(19) United States
(12) Patent Application Publication
(10) Pub. No.: US 2009/0013681 A1
(43) Pub. Date: Jan. 15, 2009

(54) Energized Fluid Motor and Components

(76) Inventor: Geoffrey B. Courtright, Naples, FL (US)

Correspondence Address: Melanie R. Martin-Jones;Porter Wright Morris & Arthur, LLP, 41 S. High Street, Columbus, OH, 43215, US

(21) Appl. No.: 11/776,778

(22) Filed: Jul. 12, 2007

(51) Int. Cl. F15B 11/00

(52) U.S. Cl. 60/327; 60/413; 91/418

(57) ABSTRACT

A motor comprising a least one piston slideable within a cylinder with a seal, a plurality of valves, means to determine the position of the valves and a head of the piston, means to select the ports in which to transfer energized fluid/exhaust in and out of the cylinder, and a scotch yoke. The cylinder comprising at least a first set of ports and a second set of ports. The ports disposed in a wall of the cylinder. The valves coupled and slideable to allow a selective transfer of an energized fluid in, and an exhaust out, of the cylinder via the ports. The scotch yoke operatively interacting with a crankshaft, the piston operatively connected to the scotch yoke such that, when the energized fluid moves the piston, torque is applied to the crankshaft, and the valves are repositioned to allow the energized fluid to enter the cylinder on the opposite side of the head of the piston and the exhaust to exit the cylinder.

An apparatus comprising a motor and an engine having a first fuel supplier supplying an oxidizer and a second fuel supplier supplying a dense fuel. The engine producing power to drive a ducted fan. The apparatus optionally comprising a hydraulic system.

### FIELD OF THE INVENTION

The present invention relates to a motor and components and more specifically to the production and control of fluids for use in a cylinder/piston motor.

### BACKGROUND OF THE INVENTION

Converting energy into useful work by driving a piston in a cylinder is well known. Pressure is used to push the piston contained in the cylinder. The piston is typically connected to a crankshaft by a rod extending from the cylinder. The movement of the piston converts the pressure into rotating mechanical energy.

Most pistons move in a cylinder as a result of internal combustion, provided by the ignition of petrol, diesel fuel, oil, natural gas and the like to provide pressure. The combustion of these fuels, however, presents environmental concerns about air pollution.

An alternative to internal combustion engines is the use of compressed air, steam or other hot gases to drive the piston. A type of steam engine is the double-acting steam engine, which has a cylinder with two openings from which the steam can enter on either side of the piston to provide pressure. Double-acting steam engines work via a slide valve that allows steam to enter the cylinder on one side of the piston, causing the piston to move away from the pressure and pushing the exhaust steam located on the other side of the piston out of the cylinder through an exhaust. The piston's action operates the slide valve so that the valve moves with the piston, alternately introducing the steam on one side of the piston to push it to one side and to the opposite side to push it back. A disadvantage of the double acting steam engine is that the steam, due to entering the cylinder via the same port that the exhaust uses to exit, cools before it enters the cylinder, thus providing less energy available to move the piston to supply power.

A solution to the cooling problem of the double acting steam engine is the uniflow steam engine. In a uniflow system, steam moves in one direction while entering and exhausting the cylinder via inlet ports at either end of the cylinder and outlet ports near the center of the cylinder. Steam flow is controlled by separate valves. The uniflow steam engine, however, operates with rapid short opening times of the inlet valves, causing fatigue and eventual breakdown of the valves.

An additional problem with existing steam engines is torque. Torque is a measure of force necessary to cause an object to rotate. A given amount of torque is required to move a stationary load; a different amount of torque is required to keep the load in motion. While a steam engine can provide maximum torque from a dead stop, if the load is too much for the piston, the piston breaks. Due to pressure rapidly rising and falling in the cylinder, variations in torque are produced and additional components, such as a flywheel must be added to smooth out the unevenness.

A device that addresses uneven torque problems is the scotch yoke. A scotch yoke translates the linear motion of the piston into rotary motion though a crank connector positioned in a guideway. As the piston moves linearly, the crank connector is rotated. The scotch yoke provides higher torque with a lighter and more efficient conversion of rotational motion with a smoother operation and fewer moving parts than a conventional crankshaft. The piston or other reciprocating part is directly coupled to a sliding yoke with a slot that engages a connector attached to the crank disk.

Engines work by extracting energy from fuels. Fuels are any materials that can be burned to release energy. Liquid fuels are commonly used to supply energy. Liquid fuels share certain attributes, such as hydrogen based compounds, including hydrogen and or hydrocarbons. The molecular structure and the amount of hydrocarbons in a liquid fuel affects its properties. For example, gasoline ignites more easily than diesel fuel because gasoline has a lower energy density and is therefore more volatile than diesel fuel; however, gasoline ignites at a higher temperature than diesel fuel because gasoline has a higher octane rating (octane measured relative to a mixture isomers to determine autoignition resistance). A low tendency to autoignite is desirable in a gasoline engine to avoid back firing. Using higher combustion temperatures in an engine results in a faster burn rate, producing more power from a smaller engine. Diesel fuel will, however, deliver more energy than gasoline if given sufficient time to burn because diesel fuel has a higher energy density than gasoline (the energy density of gasoline is about 31.60 MJ/L; diesel is about 35.5; gasoline contains about 150,000 BTU/gal; diesel about 170,000).

To control the burn of a fuel, fuels are typically ignited in a chamber that includes a fuel injector and an exhaust system and provides the ability to control pressure and temperature. A mixture of fuel and air containing oxygen will ignite when the concentration and temperature of reactants are sufficiently high. Alternately, an ignition source or a detonation device may be used to initiate combustion or to detonate the air/fuel mixture. A typical ignition device used in engines is an electrical charge, such as that produced by a spark plug.

A spark plug or other ignition device creates an electrical current that ignites the air/fuel mixture in the combustion chamber. An efficient burn is achieved through the use of proper timing of the spark, the proper heat range, and the appropriate voltage requirements for the given fuel.

After the fuel is ignited, it burns. Combustion is an incomplete burn of the fuel. Incomplete combustion occurs when too little oxygen is supplied for too little time for the fuel to burn completely. The fuel burns, but produces numerous by-products. For example, when a hydrocarbon burns completely, the reaction typically yields carbon dioxide and water. In incomplete combustion, the burn also produces numerous toxic by-products, such as carbon monoxide and nitrogen oxides. Incomplete combustion is a problem because these by-products can be quite unhealthy and damaging to the environment.

On the other hand, the complete burning a fuel—known as detonation—produces minimal by-products. Detonation burns the fuel to its basic components. Detonation is achieved through factors such as the provision of an optimum amount of air, optimum mixing of the air with the fuel, high initial temperatures, and proper design of the combustion chamber. In existing engines, “complete” burning is usually not achieved; even “near complete” fuel burning typically yields minor amounts of by-products.

The burning of a highly caloric fuel generally results in an incomplete burn producing toxic by-products. To control these by-products, existing engines are made to deliberately drop the temperature and pressure in the chamber immediately after combustion starts but before detonation occurs to avoid the stress and heat produced by such a large amount of energy. Existing engines attempt to avoid detonation by exhausting the gases of combustion from the chamber while they are still burning. In so doing, toxic by-products have the potential to enter the environment. Due to pollution standards for motor vehicles in the United States and abroad, additional components, such as catalytic converters, must be added to the exhaust system to remove these toxic by-products.

The main reason for the deliberate release of energy is that standard internal combustion engines are not designed to handle the temperature and pressure necessary for complete detonation. Standard internal combustion, which is somewhat pressurized but not for a sufficient period of time to allow for a complete burn, is inefficient and requires elaborate heat exchangers and catalytic converters to capture lost heat and control pollution. Higher oxidized combustion coupled with elaborate heat exchangers, lubrication systems, cooling systems and the like, can provide energy with less pollution while maintaining a portion of the heat, but such a design increases the cost of the engine.

Not only does the cost of the engine increase because of the additional components, but the typical practice of releasing gases while the fuel is burning in existing engines is very inefficient. The amount of heat that is removed in a typical engine to avoid the production of toxic by-products can reduce the torque of an engine by over 100%. The inefficient deliberate loss of energy causes poor engine performance, so manufacturers resort to higher frequencies of ignitions to increase power. The increase in combustion events results in higher average heat transfer rates from the hot burned gases to the walls of the chamber. These higher temperatures cause thermal stress to a typical engine.

Timing of the introduction of the fuel, ignition, combustion or detonation, exhaust and reintroduction of the cycle are key factors in the efficiency of an engine. Ignition rates are typically based on the type of fuel and the amount of power needed. For example, the burn of a highly caloric fuel, which produces higher flame temperatures in combustion, requires more time between ignitions to decrease the temperature. Ignition rates increase upon the need for additional power and are low when the machine is at rest.

The pressure inside the chamber is in part a factor of ignition rates and exhaust rates. The greater the ignition rate, the higher the pressure in the chamber; the greater the exhaust rate, the lower the pressure in the chamber. Pressure is also related to temperature. As the temperature in the chamber drops, the pressure drops.

To obtain the optimum temperature and pressure necessary to minimize toxic byproducts, sensors are added to monitor the fuel burning process. Pressure sensors measure pressure by comparing a reference to the level of charge flow associated with a specific level of pressure. Pressure is dependent upon atmospheric conditions and altitude. Temperature sensors typically used in fuel burning are any type of temperature sensor appropriate for sensing the temperature under such conditions.

In a machine, pressure and temperature sensors are generally used to feed data to a controller, such as a process logic controller (PLC), which in turn controls the pressure, temperature, ignition, and the like. A PLC is a computer designed for monitoring and controlling equipment by accepting signals from the sensors and other sources and applying the data to a set of instructions within its memory.

Many attempts have been made to provide low cost, efficient engines. One example is the steam engine, which uses a fuel to change the state of a liquid (typically, water, but other fluids may be used). Steam engines work by using the heat energy in the fuel to heat the liquid to a high-pressure steam state. When heat is transferred to a liquid, such as water, the water heats and boils and is eventually evaporated or vaporized. The pressure of water when heat is applied in a closed system increases in proportion to the temperature. When water in a sealed tank is heated, pressure builds up.

Water, however, resists vaporizing. Water has a high specific heat capacity and a high heat of vaporization due to the strong inter-molecular hydrogen bonds that must be broken during vaporization. A large amount of energy (about 41 kJ/mol) is required to evaporate water.

Existing engines suffer from the problem of not being able to efficiently generate a sufficient amount of energy to vaporize water without producing harmful by-products. U.S. Pat. No. 4,240,259 to Vincent (“Vincent”) describes a boiler with an external combustion chamber that heats water in a pressure chamber to produce steam. Standard boiler combustion is essentially not pressurized and requires the recapture of heat. For continuous, highly oxidized combustion to be “clean burning” and “pollution free” as described in Vincent, the temperature of the burn must be kept artificially low to prevent nitrogen/oxygen toxic by-product formation. Vincent addresses the heat loss by recovering steam in a steam accumulator. The steam is re-pressurized and used again. Such a design, however increases the cost of the engine and decreases performance.

Another method of increasing the efficiency of the energy used to vaporize water is by using a heat sink to expose larger surface areas of water to the energy. A heat sink is a system capable of absorbing heat from an object with which it is in thermal contact without a phase change or a significant variation in temperature. Where heat is introduced to as much water surface area as possible, the pressure build up occurs more rapidly.

Insulating materials are another method of retaining heat in the creation of large amounts of energy. By using an insulator, energy is conserved to increase operational efficiency and reduce fuel costs. Selecting insulating materials usually depends upon heat resistance and cost. The insulation material can also be coated with a protective covering.

Currently, no low cost engine exists that efficiently burns a fuel without the production of toxic by-products. Accordingly, a need exists for an engine that is optimally designed to burn a fuel without additional components, such as catalytic converters and external re-pressurization devices. A need exists for a highly efficient, low cost engine that extracts energy from a fuel to create an energized fluid that can be used to do work.

Motors may also be fully or partially powered by compressed air. The addition of compressed air to move a piston provides extra torque upon demand. Using compressed air to augment a motor powered by other fuels or energized fluids, such as steam, provides acceleration as well as braking with little additional weight. The air may also be used for providing oxygen to burn the fuel and or create the steam. Stored compressed air has the additional advantages of being non-toxic and non-explosive.

Ducted fans are used in conjunction with motors to provide thrust or generate energy. Ducted fans use ducts to accelerate air and or fluid flow drawn into the fan out through an exhaust. Ducted fans are used in a variety of commercial applications from computers to aerospace. A ducted fan provides the advantage of higher static and low speed thrust over non-ducted fans used to generate power.

Use of oxidizers, such as nitrous oxide and hydrogen peroxide, as an alternative fuel source alone or with other fuels for powering motors and components has been described. These propellants are available in commercial concentrate form and provide the advantages of low-cost of production and safety in harsh and or anaerobic environments. Nitrous oxide and hydrogen peroxide are useful as fuels and or oxygen sources in anaerobic environments, decomposing into energy and oxygen when exposed to a catalyst. Energy from the oxidizer can be transferred to a hydraulic system and or used to provide heat. Hydrogen peroxide produces steam and oxygen when exposed to silver, platinum, and the like. Nitrous oxide decomposed when exposed to a heated iridium based-commercial catalyst. Use of hydrogen peroxide as a monopropellant is described J. Raade, T. McGee and H. Kazerooni, “Design, Construction and Experimental Evaluation of a Monopropellant Powered Free Piston Hydraulic Pump”; ASME International Mechanical Engineering Congress, Washington, D.C., November 2003 (incorporated herein by reference).

Hydraulic systems are also well know. Hydraulic systems convert hydraulic energy into mechanical energy. A hydraulic system may be used in the piston of the motor itself, or the piston may generate pressure on a contained fluid to provide hydraulic energy for use by a machine. Hydraulic motors are typically enclosed and self-contained, thus allowing them to be submerged or operated in anaerobic environments. Hydraulic systems can be unidirectional or reversible, axial or radial. Hydraulic motors are useful for high pressure, high torque, low speed applications. Hydraulic motors are useful in environments without oxygen, such as aerospace, construction, drilling, marine, mining, and the like.

A need exists for a durable motor that uses an energized fluid, such as steam, to drive a piston that has few moving parts and provides the maximum amount of energy to move the piston to supply power. A need exists for a motor that generates torque to the maximum pressure starting from zero revolutions per minute without harming the motor or providing uneven torque. A need exists for a motor that provides extra torque upon demand without adding a large amount of additional weight. A need exists for a motor having components powered by a fuel that operates in an anaerobic environment.

### SUMMARY OF THE INVENTION

The present invention is a motor that works by the movement of a piston in a chamber. A rod of the piston is attached to a scotch yoke. The scotch yoke is attached to a crank shaft. As the piston moves forward and backward by applying pressure to first one side of the piston in one stroke and then to the other side of the piston in the reverse stroke, the scotch yoke turns the crank shaft. In an embodiment, the motor has only two basic moving parts and does not require a transmission. Alternately, a transmission (manual or automatic) or additional components may be integrated if desired.

In an embodiment, the motor is a one-stroke motor. Every stroke of the piston is a power stroke. Depending on the direction of the desired rotation of the crankshaft, the fluid is fed into a side of the piston and then released by valves activated mechanically by attachments to the scotch yoke.

In an embodiment, a second piston is added. In an embodiment, the second piston horizontally opposes the first piston. In an embodiment, the second piston is at any angle in relation to the first piston. In an embodiment, each piston is attached to a scotch yoke by a rod. In an embodiment, the pistons are attached to the same scotch yoke. The use of a second piston doubles the torque applied to the crank shaft. In an embodiment, a quad-piston unit is created by integrally coupling a double-piston-scotch-yoke unit to another double-piston-scotch-yoke unit at an about 90 degree angle. In an embodiment, the quad-piston unit has a 4-fold gain in torque.

In an embodiment, any number of individual pistons that will fit together at various angles can be connected to a crankshaft creating a group of two to x number of pistons. In an embodiment, pistons may be coupled to a single scotch yoke or to individual scotch yokes. In an embodiment, two or more groups of piston units can be ganged together along the same crankshaft to create a motor producing any desired torque. The present invention includes a single piston, multiple pistons, and gangs of groups of pistons of various sizes. By selecting the number and arrangement of pistons, the present invention presents a key advantage of efficiency of size and torque when compared to any other motor.

The present invention comprises a motor comprising a piston slideable within a cylinder with a seal. Optionally, the piston has at least one ring. The cylinder comprises a first set of ports and a second set of ports, each of which are disposed in a wall of the cylinder. The motor comprises a plurality of valves that are slideable to allow a selective transfer of a fluid in and out of the cylinder via the ports.

The motor comprises a scotch yoke operatively interacting with a crankshaft. The piston is connected to the scotch yoke such that movement of the piston applies torque to the crankshaft. The motor may comprise multiple piston and scotch yoke arrangements. Examples of these arrangements include but are not limited to 1) a motor comprising a second piston in a second cylinder connected to the scotch yoke; 2) a second piston connected to an opposite side of the scotch yoke; 3) at least two double pistons connected to the same crankshaft; 4) at least one single piston and at least one double piston connected to the same crankshaft; 5) two or more piston units each having their own valves and scotch yokes connected to the same crankshaft at various angles in relation to each other, any combination of the above, and the like. One skilled in the art would understand that any combination of pistons, scotch yokes and crankshafts are possible.

The motor comprises means to determine the position of the piston in the cylinder and means to select the ports in which to transfer the fluid in and out of the cylinder. The position of the sliding bar controls fluid access/egress to the cylinder. The valves of the sliding bar are positioned adjacent to the port to allow flow in and out of the cylinder. The sliding bar is manipulated by the scotch yoke pushing on an arm that extends from the sliding bar. The positioning of the bar determines the direction of the motor, which may operate in a forward, reverse, or stopping manner. By controlling the position of the valves, the motor operates equally efficiently in forward or reverse or as a powerful braking system.

In an embodiment, the motor of the present invention is fed a pressurized gas from an engine producing an energized fluid. In an embodiment, the energized fluid is fed from an engine comprising a detonation chamber in thermal communication with a tank, a fuel system connected to the chamber, and a controller wherein energy from fuel detonations in the chamber is transferred to a fluid in the tank. The engine is connected to the motor via a gas delivery system.

In an embodiment, one engine provides energized fluid to one piston. In an embodiment, one engine provides energized fluid to multiple pistons. In an embodiment, multiple engines provide power to multiple pistons. In an embodiment, multiple engines feed at least one piston. In an embodiment, the energized fluid is fed directly from the engine. In an embodiment, an energized fluid is fed to one or more piston from at least one storage tank. In an embodiment, the energized fluid is fed from an engine and a storage tank. Such an arrangement produces increased power on demand. As an example, but not to limit this disclosure, such an arrangement is employed for increased torque to drive a transmission of a vehicle during acceleration.

The flow of the energized fluid of the present invention provides for higher cylinder pressures and higher compression pressures so that higher efficiencies can be realized.

The present invention comprises a motor comprising at least one piston slideable within a cylinder with a seal. The cylinder comprising at least a first set of ports and a second set of ports. The ports disposed in a wall of the cylinder. The motor comprises a plurality of valves. The valves are coupled and slideable to allow a selective transfer of an energized fluid in, and an exhaust out, of the cylinder via the ports. The motor comprises 1) means to determine the position of the valves and a head of the piston and 2) means to select the ports in which to transfer the energized fluid in and the exhaust out of the cylinder. In an embodiment the means is a controller. The motor comprises a scotch yoke operatively interacting with a crankshaft. The piston is operatively connected to the scotch yoke such that, when the energized fluid moves the piston, torque is applied to the crankshaft, and the valves are repositioned to allow the energized fluid to enter the cylinder on the opposite side of the head of the piston and the exhaust to exit the cylinder.

The present invention further comprises an engine. The engine is interconnected to the cylinder and provides the energized fluid. The engine is interconnected to a first fuel supplier supplying an oxidizer and a second fuel supplier supplying a dense fuel.

The present invention further comprises a compressed air system. The compressed air is injected into the cylinder to move the piston and into the engine to detonate a fuel. The present invention further comprises a ducted fan. The present invention further comprises a motor that drives a hydraulic system. In an embodiment, the hydraulic drive uses conventional principles to provide forward or reverse rotation to the blades of the ducted fan. In an embodiment, a byproduct from a detonation in the engine is directed to the intake of the ducted fan. Introduction of byproducts provides a boost in thrust by increasing the density of the incoming air thereby making the ducted fan produce more thrust. In an embodiment, the present invention comprises ducted fans of differing sizes. In an embodiment, byproducts from the detonation are directed to a ducted fan to create a denser intake mass for the ducted fan so that it can generate more thrust. In an embodiment, the hydraulic system drives the rotation of the blades of at least one ducted fan to provide reverse or forward thrust, while one or more secondary ducted fans provide reverse or forward thrust of a considerably smaller magnitude in a different direction than the first fan. In an embodiment, the secondary ducted fans provide differential thrust to produce a three-dimensional moment, such as for steering.

In an embodiment the present invention produces power via exposing an oxidizer to a catalyst; providing oxygen resulting from the catalyzed oxidizer to the engine to detonate the dense fuel; collecting water resulting from the catalyzed oxidizer in a tank; collecting energized fluid resulting from the catalyzed oxidizer in a reservoir; contacting the water to a side of the engine to create additional energized fluid from energy produced by the detonation; directing the energized fluid to a port on a cylinder of the motor to move the piston; compressing a liquid contained in the hydraulic system through the movement of the piston; exhausting the cooling energized fluid to the reservoir; directing the byproducts to the air intake side of the ducted fans; directing the compressed liquid to drive the ducted fans; collected the liquid after exiting the ducted fans; and returning the liquid to the hydraulic system.

“Fluid(s)” as used herein is intended to encompass both gaseous and liquid media.

As used herein, “approximately” means within plus or minus 25% of the term it qualifies. The term “about” means between ½ and 2 times the term it qualifies.

The devices and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### BRIEF DESCRIPTION OF THE DRAWINGS

FIG. 1 is a sectional view of an embodiment of the present invention.

FIG. 2 is an alternate sectional view of an embodiment of the present invention.

FIG. 3 is a flow diagram of a method of an embodiment of the present invention.

FIG. 4 is a sectional view of an alternate embodiment of the present invention.

FIGS. 5a-5f depict various crankshaft connections of embodiments of the present invention.

FIG. 6 is a sectional view of an embodiment of the present invention depicting a quad piston arrangement.

FIG. 7 is a sectional view of an embodiment of the present invention depicting an example of the relationship of a first piston to a second piston.

FIGS. 8a, 8b and 8c are modular depictions of the components of several embodiments of the present invention.

FIG. 9 is a modular depiction of the interaction of components of an embodiment of the present invention.

FIG. 10 is a modular depiction of the interaction of components of an alternate embodiment of the present invention.

FIG. 11 is a flow diagram of a method of an embodiment of the present invention.

FIG. 12 is a flow diagram of a method of an embodiment of the present invention.

FIG. 13 a modular depiction of the interaction of components of an alternate embodiment of the present invention.

FIG. 14 a modular depiction of the interaction of components of an alternate embodiment of the present invention.

FIG. 15 is a modular depiction of the uses of the oxidizer.

FIG. 16 is a cross-sectional view of an embodiment of the present invention.

FIG. 17 is a flow diagram illustrating a method of operating the engine of FIG. 1.

FIG. 18 is a schematic diagram showing the flow of oxidizer, fuel and detonation products in an embodiment.

FIG. 19 is a schematic diagram of the flow of fluid in an embodiment.

### DETAILED DESCRIPTION OF THE INVENTION

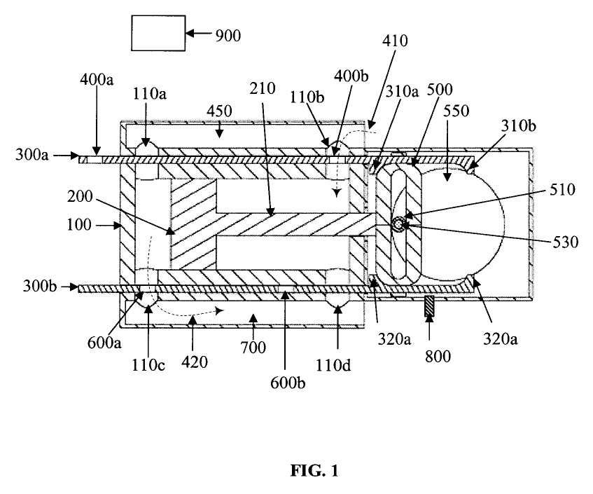

As depicted in FIG. 1, the motor of the present invention comprises at least one cylinder 100 enclosing a piston 200. The piston 200 comprises a piston shaft 210 that extends through an end wall of the cylinder 100. Optionally, the piston 200 has at least one ring. The piston 200 is slideable in the cylinder 100. The point of contact of the piston shaft 210 with the wall of the cylinder 100 comprises a seal and or at least one bearing. The size of the cylinder 100 and the length of the piston shaft 210 vary based upon application of the motor. The piston and cylinder are of any design and size acceptable for use in a motor. In an embodiment, a minimal length piston shaft 210 is used to provide higher acceleration.

In an embodiment, a first sliding bar 300a and a second sliding bar 300b are in communication with a wall of the cylinder 100. A side wall of the cylinder 100 comprises a first set of ports 110a 110b and a second set of ports 110c 110d. The first sliding bar 300a comprises a first set of valves 400a 400b. The second sliding bar 300b comprises a second set of valves 600a 600b. The first sliding bar 300a is in communication with 1) the wall of the cylinder 100 comprising a first set of ports 110a 110b and 2) an energized fluid inlet 450, such that when the first set of valves 400a, 400b align with the first set of ports 110a 110b to allow an energized fluid flows from the energized fluid inlet 450 to enter the cylinder 100 through the first set of ports 110a 110b. The second sliding bar 300b is in communication with 1) the wall of the cylinder 100 comprising a second set of ports 110c 110d and 2) a fluid outlet 700, such that the second set of valves 600a, 600b align with the second set of ports 110a 110b to allow cooling fluid to exit the cylinder 100 through the second set of ports 110c 110d into the fluid outlet 700. The first set of ports 110a 110b and the second set of ports 110c 110d are positioned generally on opposite sides of the walls of the cylinder 100 from each other. The first set of ports 110a 110b are positioned on the wall of the cylinder 100 such that each port provides access to the cylinder on opposite sides of the piston 200. The second set of ports 110c 110d are positioned on the wall of the cylinder 100 such that each port provides access to the cylinder on opposite sides of the piston 200.

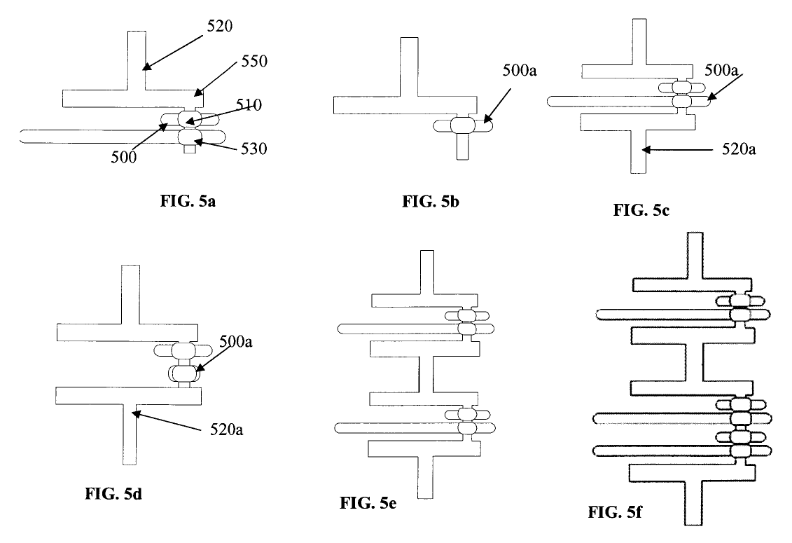

In an embodiment, the piston shaft 210 is connected to a scotch yoke 500 operatively interacting with a crankshaft 520 (shown in FIG. 5). A slot in the scotch yoke 500 engages a crank connector 530 on a crank disk 550. Rotation of the crank disk 550 turns the crankshaft 520. In an embodiment, friction and wear are minimized, such as but not limited to by using a crank connector roller bearing 510. The size of the crank connector 530 depends upon the pressure exerted by the movement of the piston. For example, a larger or more powerful crank connector 530 is used where the pressure exceeds about 400 pounds.

In an embodiment, the first sliding bar 300a comprises at least two first sliding bar arms 310a 310b. In an embodiment, the second sliding bar 300b comprises at least two second sliding bar arms 320a 320b. In an embodiment, where the sliding bars are connected, a single set of arms are used.

In an embodiment, the second sliding bar arms 320a 320b are positioned at a generally opposite end of the slot of the scotch yoke 500 from the position of the first sliding bar arms 310a 310b. In an embodiment, the arms are positioned such that movement of the piston 200 moving the scotch yoke 500 presents a force that displaces either sliding bar arms 310a 320a or 310b 320b. In an embodiment, movement of the arm moves the sliding bars such that values in 400a 400b 600a 600b in communication with the arms, are moved in and out of alignment with the ports 110a 110b 110c 110d.

In an embodiment, the motor comprises means to determine the position of the piston 200. In an embodiment, the determining means is a sensor 800. In an embodiment, the sensor 800 is any type of sensor capable of determining position, such as but not limited to, pressure, microwave, magnetic, electromagnetic, optic, and the like. In an embodiment, at least one sensor 800 provides data regarding the speed of the motor, such as but not limited to the revolutions per minute of the crankshaft.

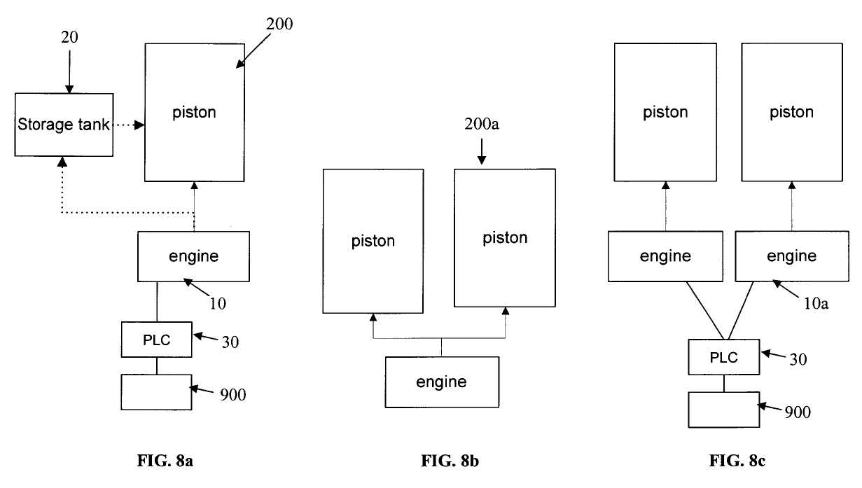

In an embodiment, the motor comprises a controller 900. In an embodiment, the controller 900 is a process logic controller (PLC). In an embodiment, the controller 900 is designed to operate under higher temperatures and is capable of operating during vibrations, jolts, and the like. The controller 900 comprises mechanical and process control, data detection, processing, manipulation and storage, communication, programming and updating capabilities, a user and or machine interface, and the like. The controller 900 is powered by an internal or external power source. In an embodiment, each piston is controlled by a controller 900. In an embodiment, each controller 900 is controlled by a master PLC 30. In an embodiment, one controller 900 controls more than one piston. In an embodiment, at least one controller 900 is in communication with a master PLC 30 that orchestrates the control and function of each piston 200 and the engine 10 (FIG. 8a-c). In an embodiment, the controller 900 controls a regulator in the inlet 450 and the outlet 700 and a solenoid in each. The regulators determine the amount and the direction of flow of the energized fluid.

In an embodiment, the sensor 800 is in communication with the controller 900. In an embodiment, controller 900 comprises means to select the ports 110a 110b, 110c 110d in to which to transfer the fluid in and out of the cylinder 100.

In an embodiment, the movement of the piston 200 starts from any position and travels in either direction, such that the motor operates in a forward or reverse manner. The positioning of the sliding bar arms 310a 310b, 320a 320b determines direction of movement of the piston 200 which determines the rotation of the crank disk 550 in communication with the scotch yoke 500. The rotation of the crank disk 550 governs the direction of rotation of the crankshaft 520 and the direction of a machine in communication with the crankshaft. By controlling the valve position, the present invention operates equally efficiently in forward or reverse and provides braking.

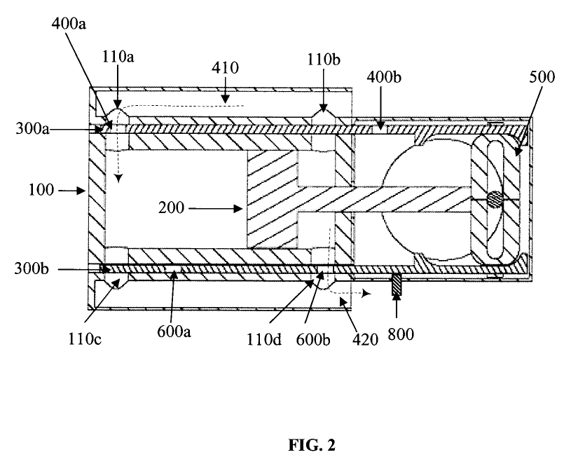

FIG. 1 depicts an embodiment of the present invention with sliding bar arms 310a 320a pushed by the scotch yoke 500 such that valve 400b is aligned with port 110b to allow energized fluid to flow into the cylinder 100. Arrow 410 indicates the flow of energized fluid. The energized fluid pushes the piston 200, the movement of which exhausts the cooling fluid on the opposite side of the piston 200 out of the cylinder via port 110c due to the alignment of valve 600a. Arrow 420 indicates the flow of cooling fluid. As shown in FIG. 2, when the scotch yoke 500 pushes sliding bar arms 310b 320b, valve 400a is aligned with port 110a to allow energized fluid to flow into the cylinder 100. Arrow 410 indicates the flow of energized fluid. The energized fluid pushes the piston 200, the movement of which exhausts the cooling fluid on the opposite side of the piston 200 out of the cylinder via port 110d due to the alignment of valve 600b. Arrow 420 indicates the flow of cooling fluid.

In an embodiment, the rpms of the motor range from about 0 to about 10,000 rpms. In an embodiment, the rpms range from about 0 to about 5,000 rpms. In an embodiment, the motor running range is about 5000 to about 7,500 rpms.

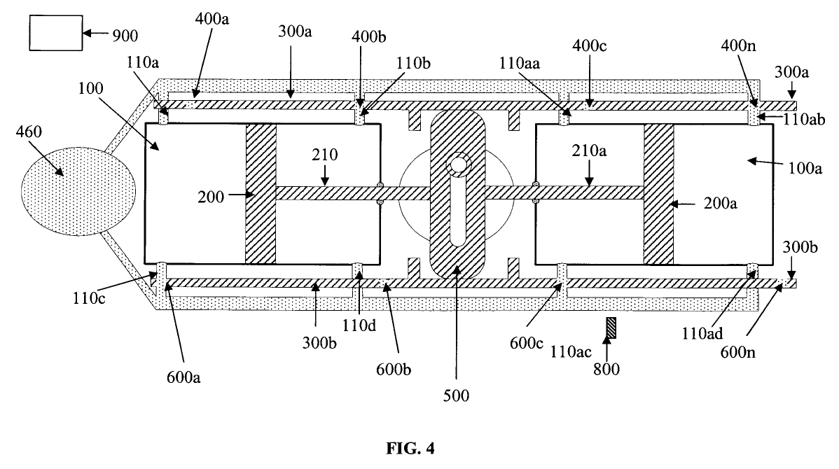

In an embodiment depicted in FIG. 4, an additional cylinder 100a/piston 200a is connected to the scotch yoke 500 via piston shaft 210a. In an embodiment, the second piston shaft 210a is at a 180 degree angle from the first piston shaft 210. In an embodiment, two pistons are connected to the same scotch yoke and use the same valves. In an embodiment, at least two of the double pistons described in the foregoing sentence are connected to the same crankshaft. In an embodiment, the double pistons may be at any angle in relation to each other. The double pistons may be in the same plane or in other planes in relation to each other.

In an embodiment, two or more pistons having their own independent valves and scotch yokes are connected to the same crankshaft at a variety of angles. In an embodiment, the second piston having a separate scotch yoke is connected at a 90 degree angle to the first piston. Where two pistons/cylinders are horizontally opposed, the configuration shares sliding valves. Any piston and scotch yoke that is not directly attached horizontally to another piston has an independent set of sliding valves on its cylinder. In an embodiment, at least one additional piston is connected to the crankshaft at either equal distances or unequal distances from the first piston. In an embodiment, at least two or more pistons are connected at any angle between 0 and 360 degrees. The pistons may be at some other angle in relation to each other. The pistons may be in the same plane or different planes from each other.

In an embodiment depicted in FIG. 4, sliding bar 300a comprises an additional first set of valves 400c, 400n and sliding bar 300b comprises an additional second set of valves 600c 600n. The additional sets of valves are positioned to align with additional first set of ports 110aa 110ab 110ac 110ad in cylinder 100a. The fluid inlet 450 and the fluid outlet 700 extend to service cylinder 100a and piston 200a.

In the embodiment depicted in FIG. 4, when the scotch yoke 500 pushes sliding bar arms 310b 320b, valve 400b is aligned with port 110b to allow energized fluid to flow into the cylinder 100 and valve 400n is aligned with port 110ab to allow energized fluid to flow into the cylinder 100a. The energized fluid introduced in cylinder 100 pushes the piston 200, the movement of which exhausts the cooling fluid on the opposite side of the piston 200 out of the cylinder via port 110c due to the alignment of valve 600a. The energized fluid introduced in cylinder 100a pushes the piston 200a, the movement of which exhausts the cooling fluid on the opposite side of the piston 200a out of the cylinder via port 110ac due to the alignment of valve 600c. As depicted in the embodiment of FIG. 4, the cooling fluid is returned to an engine 460 via the fluid outlet 700 to be energized and reintroduced to a cylinder via fluid inlet 450.

In an embodiment depicted in FIGS. 5a 5f, each scotch yoke 500 is coupled to one crankshaft 520 via the crank connector 530. The addition of a second piston and scotch yoke 500a (FIG. 5b) approximately doubles the overall torque to the crankshaft. Any number of pistons (odd or even) and scotch yokes could be coupled together to one crankshaft 520 via one or more crank connector 530. FIG. 5c depicts an embodiment with additional scotch yoke 500a connected to an additional crankshaft 520a at an approximate 90 degree angle. FIG. 5d depicts an embodiment with an additional scotch yoke 500a connected to an additional crankshaft 520a at an angle other than 90 degrees. FIG. 5e depicts a combination of scotch yokes connected to an at least two crankshafts. FIG. 5f depicts multiple combinations of scotch yokes connected to multiple crankshafts. In an embodiment, multiple scotch yokes are in communication with one crank connector. In an embodiment, multiple scotch yokes are in communication with multiple crank connectors on one crankshaft. In an embodiment having scotch yokes in different parallel planes, all are perpendicular to the crankshaft. In an embodiment where the scotch yokes are in different parallel planes, and not perpendicular to the crankshaft, the present invention comprises a gear system to change the direction of the crankshaft. The size of the piston and the cylinder is of any circumference. By varying the sizes of piston(s), the number of scotch yokes, and the number of individual pistons and pistons coupled to the same scotch yoke ganged together, the desired torque is created.

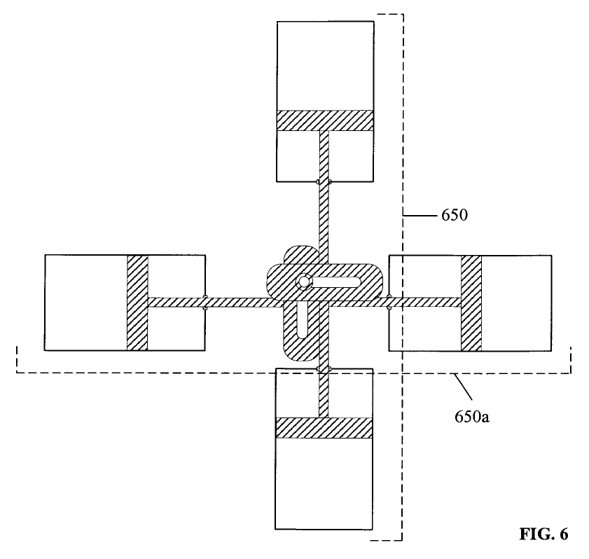

FIG. 6 depicts the quad arrangement of the present invention. In an embodiment two pistons are connected to the same scotch yoke at about 180 degrees in relation to each other to form a double piston 650. In the embodiment depicted in FIG. 6, a second double piston 650a is connected to the same crankshaft. In an embodiment the second double piston 650a is attached to the crankshaft at about an 90 degree angle to the first double piston 650. In an embodiment, the angle of attachment is other than 90 degrees. In an embodiment, more than two double pistons are added to the crank connector 530. In an embodiment, at least two double pistons are connected to the crankshaft in the same plane. In an embodiment, at least two double pistons are connected to the crankshaft in different planes.

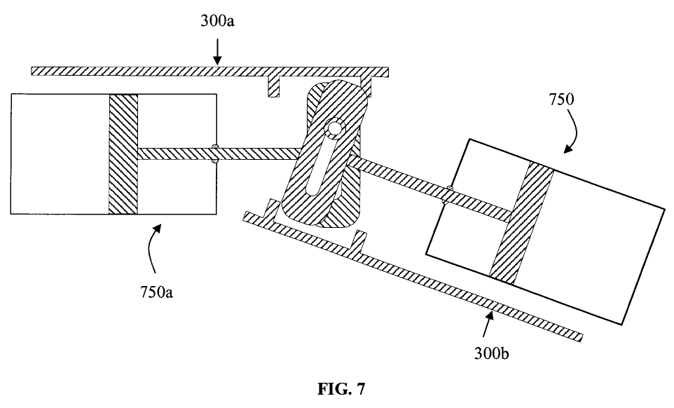

In an embodiment depicted in FIG. 7, at least one second piston/scotch yoke 750a is connected to a crankshaft at any given angle to a first piston/scotch yoke 750. In an embodiment, the first sliding bar 300a and second sliding bar 300b are arranged such that the positioning of the sliding bar arms determines direction of movement of the piston 200 which determines the rotation of the crankshaft. Each cylinder has two sliding bars (though only one is depicted in FIG. 7). In an embodiment the sliding bars are in the same plane. In an embodiment, the sliding bars are in different planes.

In an embodiment depicted in FIG. 8a, the present invention comprises at least one engine 10 and at least one piston 200 interconnected to a scotch yoke. In an embodiment depicted in FIG. 8b, one engine 10 may produce energized fluid for more than one piston 200 200a. In an embodiment depicted in FIG. 8c, more than one engine 10 10a produces energized fluid for more than one piston 200 200a. In an embodiment, the present invention further comprises at least one storage tank 20 interconnected to one or more engine 10 and at least one energized fluid inlet.

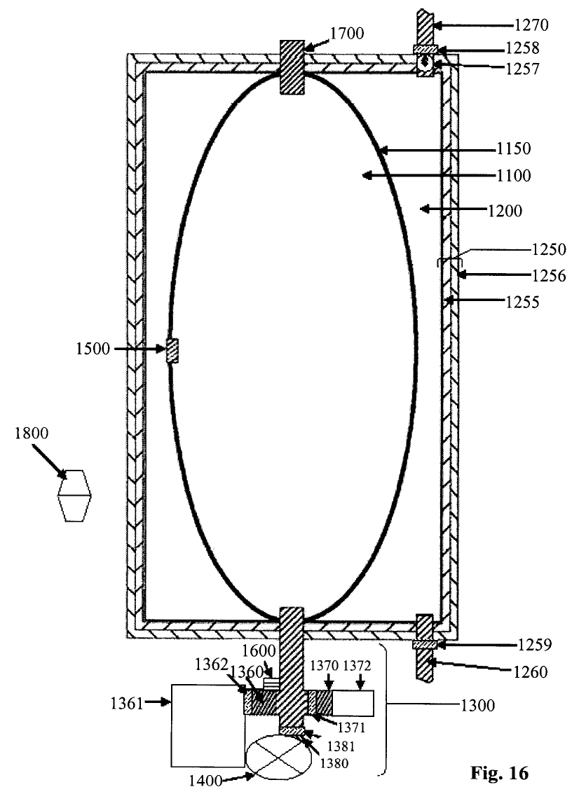

In an embodiment depicted in FIG. 16, the present invention comprises a detonation chamber 1100. The detonation chamber 1100 is a closed vessel designed to control the heat, pressure, and shock waves of repeated detonations. In an embodiment, the detonation chamber 1100 is formed of a metal, preferably steel, but any material capable of withstanding repeated detonations and high heat may be used.

The chamber 1100 is in contact with a tank 1200. In an embodiment, the chamber 1100 is immersed within the tank 1200. In an embodiment, the tank 1200 is formed of a metal, preferably steel, but any material capable of withstanding high heat may be used.

The detonation chamber 1100 comprises a wall 1150. In an embodiment, the wall 1150 comprises the outer wall of the chamber 1100 and is in contact with the tank 1200. The surface area of the wall 1150 is large, allowing for the rapid transfer of heat from the detonation chamber 1100 to the tank 1200. The wall 1150 is shaped to allow optimum thermal contact between the chamber 1100 and a fluid in the tank 1200. In an embodiment, the wall 1150 is a rounded shape.

In an embodiment, the wall 1150 comprises a heat sink. In an embodiment, the wall 1150 is a heat sink fabricated from a thermally conductive material, such as but not limited to aluminum, aluminum alloys, copper, copper alloys and conductive polymers, to provide high conductivity at a low weight and cost. In an embodiment, the wall 1150 is a heat sink comprised of a base and a plurality of fins, pins and or folds. In an embodiment, the wall 1150 is a combination of materials, such as but not limited to, aluminum and copper. The plurality of fins, pins or folds are generally vertically attached to the base to form a series of channels. One skilled in the art would understand that the wall 1150 may be of any shape and design that allows for the rapid transfer of heat from the chamber 1100 to the tank 1200.

As depicted in FIG. 16, the tank 1200 comprises at least one tank wall 1250. The tank wall 1250 defines the shape of the tank 1200. In an embodiment, the tank 1200 comprises more than one tank wall 1250 such that the tank 1200 is a closed form capable of containing a fluid. In an embodiment, the tank 1200 comprises six tank walls 1250 to form a cube, with the chamber 1100 located within the cube. The tank wall 1250 is designed to prevent heat loss from the tank 1200.

The tank wall 1250 may have insulation on the interior surface 1255, the exterior surface 1256, or both surfaces. In an embodiment, the tank wall 1250 is composed of steel with internal insulation 1255 and external insulation 1256. The insulation 1255, 1256 may be any material, such as but not limited to: fiberglass, mineral wool, ceramics, ceramic fiber, cellular glass, cellular foam, polyethylene, polystyrene, calcium silicate, perlite and insulating cements. The insulation 1255, 1256 can also be coated with a protective covering, such as coatings of cement or mastics, reinforced paper, tar paper, canvass cloth, plastic, laminates, metals, and the like. This list is not restrictive, but merely to provide examples. The internal insulation 1255 is designed to reflect the heat back into the tank 1100. In an embodiment, the insulation 1255, 1256 is a ceramic. In an embodiment, the external insulation 1256 is a ceramic blanket bonded with ceramic cement bond having a high temperature aluminum reflecting tape sealing the blanket. In an embodiment, the internal insulation 1255 is a ceramic cement. In an embodiment, the internal insulation 1255 is a waterproof, dense and highly insulating ceramic material bound to the inside of the tank wall 1250 of the tank 1200. One skilled in the art would readily understand that the tank wall 250 and the insulation 255, 256 could be composed of any suitable material and may include additional materials, coatings and the like. In an embodiment other components of the engine are insulated, such as but not limited to the tank outlet 1270, the tank inlet 1260, and the like.

As depicted in FIG. 19, the tank 1200 comprises a tank inlet 1260 and a tank outlet 1270. The tank inlet 1260 interconnects the tank 1200 to a reservoir 1210. In an embodiment, the present invention comprises multiple tank inlets 1260. The tank outlet 1270 interconnects the tank 1200 to a machine 1220 where energy from the energized fluid is extracted. In an embodiment, the energized fluid is introduced to more than one machine 1220 in a series. In an embodiment, the energized fluid is introduced to more than one machine 1220 at more or less the same time. In an embodiment, the energy from the energized fluid is stored. In an embodiment, the energized fluid is stored in one or more container. In an embodiment, the energized fluid is stored and then introduced into one or more machine. After use of all or a portion of the energy in the fluid by the machine 1220, the fluid is returned to the reservoir 1210 for reintroduction into the tank 1200. Upon reintroduction to the tank 1200, the fluid may be an energized fluid, in a normal state, or both.

Referring again to FIG. 16, the tank comprises a tank sensor 1257. The tank sensor 1257 determines a tank pressure within the tank 1200. In an embodiment, the tank sensor 1257 is an analog pressure gauge. In an embodiment, the tank sensor 1257 is an electronic pressure gauge. In an embodiment, the tank sensor 1257 is a digital pressure sensor. One skilled in the art would understand that the tank sensor 1257 is any device that provides the ability for a user and or a machine to determine the tank pressure.

The tank 1200 comprises a tank outlet valve 1258. The tank outlet valve 1258 is interconnected to the tank outlet 1270. The tank outlet valve 1258 operates to release energized fluid from the tank 1200. The tank outlet valve 1258 is closed as the fluid in the tank 1200 is energized, and opened when a desired amount of pressure in the tank 1200 is obtained. In an embodiment, the tank outlet valve 1258 is a one-way valve that only allows energized fluid to exit the tank 1200. In an embodiment, the tank outlet valve 1258 is in communication with the tank sensor 1257. In an embodiment, the tank outlet valve 1258 is opened upon the tank sensor 1257 reading a desired pressure.

The tank 1200 comprises a tank inlet valve 1259. The tank inlet valve 1259 is interconnected to the tank inlet 1260. The tank inlet valve 1259 is opened to allow fluid to enter the tank 1200. In an embodiment, the present invention comprises multiple tank inlet valves 1259. The tank inlet valve 1259 is closed when the desired amount of fluid is present in the tank 1200. In an embodiment, the tank inlet valve 1259 and tank inlet 1260 comprise a fluid injector. The fluid injector sprays small droplets of fluid into the tank 1200. In an embodiment, the injector directs the fluid to the wall 1150. In an embodiment, the tank inlet valve 1259 is a one-way valve that only allows fluid to enter the tank 1200.

The fluid is any fluid that emits sufficient energy when undergoing a state change The fluid is any gas, liquid, or mixtures thereof. In an embodiment, the fluid comprises an organic fluid. In an embodiment, the fluid comprises a refrigerant, an antifreeze, mixtures thereof, and the like. In an embodiment, the fluid comprises water, haloalkanes, ammonia, alcohols, mixtures thereof, and the like. This list is not all inclusive but is merely representative of suitable fluids. In an embodiment, the fluid is water. In an embodiment, the fluid is a mixture of fluids, such as but not limited to a first fluid and a second fluid that serves as an antifreeze for the first fluid. In an embodiment, the first fluid is water and the second fluid is an alcohol.

In an embodiment, the invention comprises a temperature gauge 1500 at the wall 1150 within the chamber 1100. The gauge 1500 may be analog or digital and is any type of temperature sensor appropriate for sensing the temperature under such conditions. The gauge 1500 can be any type that can measure a temperature in the range from below about 0° F. to over about 1000° F.

The chamber 1100 comprises a chamber pressure sensor 1600. The chamber pressure sensor 1600 compares the level of charge flow associated with a specific level of pressure to a reference. The chamber pressure sensor 1600 may be a pressure sensor, such as a gauge sensor, a differential pressure sensor, and the like. The chamber pressure sensor 1600 may be analog or digital. The pressure sensor 1600 is any type instrument that can measure a pressure in the range of about 0 psi to about 1500 psi.

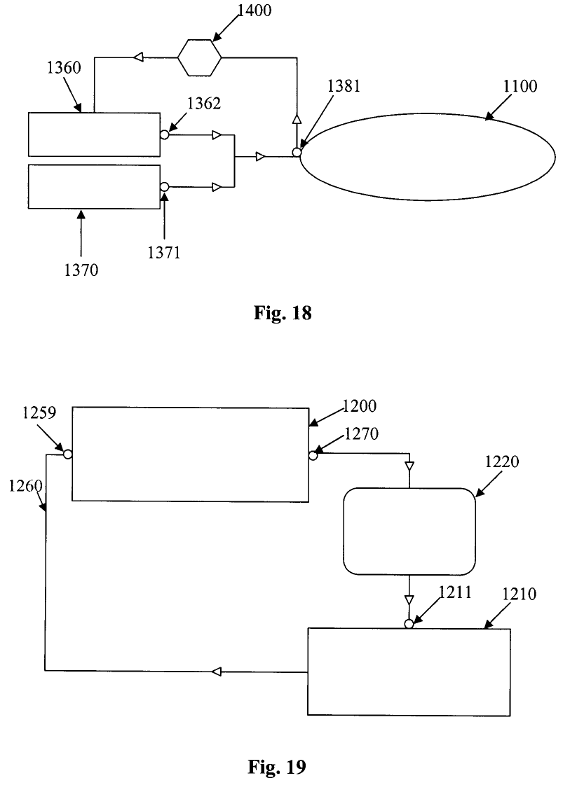

In an embodiment shown in FIG. 18, the present invention comprises a fuel system 1300 interconnected to the chamber 1100. The fuel system 1300 comprises an oxidizer source 1360, at least one fuel injector 1370, and an exhaust 1380. In an embodiment, the oxidizer source 1360 is interconnected to an oxidizer holding compartment 1361 and a compressor 1400. In an embodiment, the oxidizer source 1360 comprises an oxidizer valve 1362. The oxidizer valve 1362 operates to inject oxidizer into the chamber 1100.

The oxidizer is any compound capable of reacting with and oxidizing a fuel. In an embodiment, the oxidizer of the present invention comprises at least one of a peroxide, nitrate, nitrite, perchlorate, chlorate, chlorite, hypochlorite, dichromate, permanganate, persulfate, mixtures thereof, and the like. In an embodiment, the oxidizer of the present invention comprises air, oxygen, hydrogen peroxide, mixtures thereof, and the like. This list is not all inclusive but is merely representative of suitable oxidizers.

The fuel injector 1370 is designed to provide at least one fuel to the chamber 1100. In an embodiment, the fuel injector comprises a fuel receptacle 1372. In an embodiment, multiple fuel injectors 1370 comprise multiple fuel receptacles 1372. In an embodiment, the fuel injector 1370 comprises a fuel injector valve 1371. The fuel injector valve 1371 operates to inject at least one fuel into the chamber 1100. In an embodiment, the fuel system 1300 is in communication with the chamber sensor 1600 and the gauge 1500. The exhaust 1380 exhausts detonation products out of the chamber 100. The exhaust 380 comprises an exhaust valve 1381. In an embodiment, the oxidizer valve 1382, the fuel injector valve 1371, and the exhaust valve 1381 are one-way valves.

In an embodiment, the fuel system valves are controlled based upon the chamber sensor 1600, the gauge 1500, the oxidizer and fuel type, the fluid type and the requested amount of power. The request for power can be from a user or a machine or both. In an embodiment the request for power is for a greater amount of energized fluid.

The present invention is capable of using a wide range of fuels. In an embodiment, the fuel comprises any organic fluid. In embodiment, the fuel comprises any liquid or gaseous hydrocarbon. In an embodiment, the fuel comprises at least one of hydrogen, methane, propane, methanol, alcohol, butanol, natural gas, benzene, toluene, xylene, any petroleum oil, kerosene, gasoline, diesel, heating oil, biodiesel, ethanol, soybean oil, rapeseed oil, animal fat, microalgae oil, vegetable oil, mixtures thereof, and the like. This list is not all inclusive but is merely representative of suitable fuels. The present invention is capable of using a first fuel as a primer to increase the temperature to ignite a second fuel having a higher ignition temperature threshold. For example, a more volatile fuel, such as methane, is ignited to provide part of the energy required for the detonation of a fuel requiring a high temperature for ignition, such as heating oil.

In an embodiment, the present invention employs a low caloric fuel, such as but not limited to propane, methane, hydrogen and the like. By using a low caloric fuel, the fuel burns quickly at a relatively low temperature so that the temperature and the pressure in the chamber are kept at a lower rate during the burn. The heat from the detonation is quickly absorbed through the wall into the fluid, thus preventing the creation of toxic by-products.

Returning to FIG. 16, in an embodiment, the present invention comprises an ignition device 1700 in communication with the chamber 1100. The ignition device 1700 can be any device that ignites a fuel. In an embodiment, the ignition device 1700 is a spark plug. In an embodiment, the ignition device 1700 is controlled by output from the chamber sensor 1600, the gauge 1500, the fuel and oxidizer type, and the requested amount of power.

In an embodiment, the present invention comprises a controller 1800. In an embodiment, the controller 1800 is a PLC. In an embodiment, the controller 1800 is designed to operate under higher temperatures and is capable of operating during vibrations and jolts. The controller 1800 comprises mechanical and process control, data detection, processing, manipulation and storage, communication, programming and updating capabilities, a user and or machine interface, and the like. The controller 800 is powered by an internal or external power source.

In an embodiment, the controller 1800 is in communication with at least the fuel system 1300, the ignition device 1700, the tank inlet valve 1259, the tank outlet valve 1258, the chamber sensor 1600, the gauge 1500, and the tank sensor 1257. The controller 1800 monitors chamber 1100 pressure and temperature via readings from the chamber sensor 1600 and gauge 1500 and controls the chamber pressure and temperature by operating at least the ignition device 1700, the valves of the fuel system 1300, and tank valves 1259 and 1258. In an embodiment, chamber pressure and temperature are also dependent upon the type of fuel(s), oxidizer(s) and fluid(s) used in the invention. In an embodiment, the controller 1800 operates by receiving data from the components of the invention and applying the input to a set of instructions within its memory. The controller 1800 determines the rate and amount of oxidizer(s) and the rate and amount of fuel(s) to be injected into the chamber 1100 based on at least one of the temperature, pressure, at least one property of the fuel, oxidizer and fluid, and an amount of power requested.

In an embodiment, the controller 1800 controls the fuel system 1300 and the ignition device 1700 so that the determined amount of oxidizer at the determined oxidizer rate and the determined amount of fuel at the determined fuel rate is injected into the chamber 1100 at the optimal time to be ignited by the ignition device 1700. The controller 1800 controls the timing and amount of fluid injected into the tank 1200. The controller controls the timing and amount of energized fluid exiting the tank 1200. The controller 1800 controls the amount and time of the exhausting of exhaust products. The controller 1800 continually adjusts instructions to the fuel system 1300, the ignition device 1700, the tank inlet valve 1259, and outlet valve 1270 in response to input, such as fuel, oxidizer, and fluid type, pressure readings, temperatures and a request for power by the machine or the user. In an embodiment, the controller is linked to a control of one or more machine. In an embodiment, the controller is linked to one or more second controller.

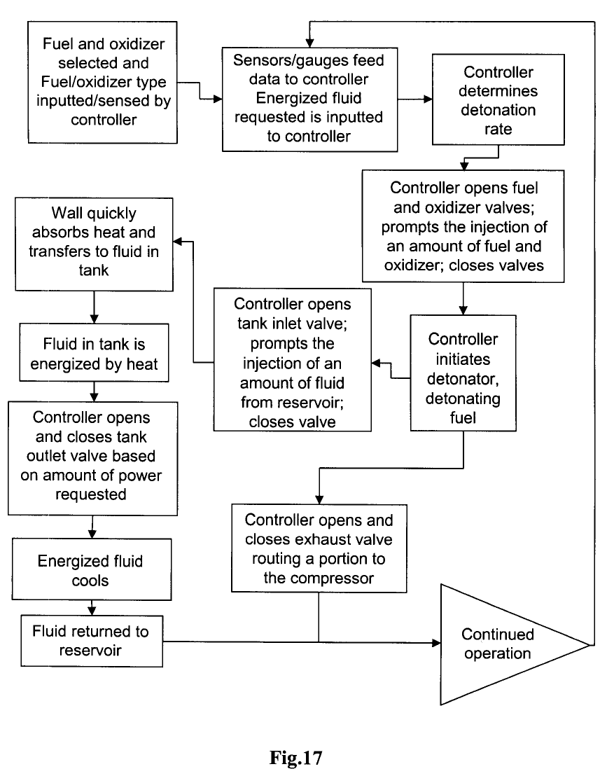

FIG. 17 is a graphic depiction of the process of an embodiment of the present invention. As shown in FIG. 17, a fuel and oxidizer are selected. In an embodiment, the present invention is pre-programmed for a given fuel and oxidizer. In an embodiment, a switch, toggle or knob is used to input the fuel and or oxidizer types into the controller. In an embodiment, the fuel and oxidizer are selected from an interaction with the controller, such as but not limited to a pull down list of options stored in the memory of the controller. In an embodiment, the present invention comprises an override switch to select the fuel and or the oxidizer.

The engine is initiated with a positive request for power. The positive request for power can be from a user, a machine, or a combination of the user and the machine. The request can be a user and or machine performing a mechanical function, such as turning a dial, pushing a button, moving a lever, and the like, that is translated to the controller, or the request can be a user and or machine directly providing a command to the controller. The positive request for power can be for a variety of functions, such as but not limited to, torque, thrust, acceleration, and the like.

During operation of the engine, a variety sensors, gauges, and other devices are in communication with the controller. When a request for power is received by the controller, the controller applies data received from the chamber sensor and the gauge to the designated fuel and oxidizer and determines a detonation rate based on the energy produced from prior detonations and the current power request. In an embodiment, the detonation rate is the fastest possible cycle that detonation will occur for the injected volumes of oxidizer and fuel.

FIG. 18 is a diagram showing the fuel system 1300 in operation. Based on the detonation rate, the controller 1800 opens the fuel injector valve 1371 to inject a calculated amount of fuel from the fuel injector 1370 and opens the oxidizer valve 1362 to inject a calculated amount of oxidizer from the oxidizer source 1360. The controller modifies the amount of oxidizer-fuel mixture introduced into the chamber based on an increase or decrease in the energy released. The controller varies the oxidizer and fuel amounts to determine the optimum mixture based on conditions, such as but not limited to altitude, which effects pressure.

In an embodiment, the present invention comprises more than one fuel injector 1370. In an embodiment, a first fuel injector is used to provide a fuel, such as methane, diesel, and the like, to the chamber 1100. The first fuel is mixed with an oxidizer and ignited, whereupon a second fuel injector provides a second fuel such as heating oil, gasoline, and the like, to the chamber 1100 where it is mixed with an oxidizer and detonated using the energy from the detonated first fuel to provide a higher temperature for the detonation.

Returning to FIG. 17, the controller closes the valves of the fuel system and activates the ignition device 1700 to detonate the oxidizer-fuel mixture in the chamber. The controller causes the ignition device to pulse such that a spark is supplied to the chamber at the moment that the oxidizer-fuel mixture is optimal. The optimal ignition timing is further established using pressure and temperature data as compared to the energy produced and the level of power requested. The controller includes the ability to map pressure in the chamber to determine peak pressure and temperature for every detonation based on the amount of power requested. In an embodiment, when a positive power request is received, the rate of detonation increases to the fastest possible rate for that oxidizer-fuel mixture until the power demand is met.

The detonation is an almost instantaneous high-pressure release of heat. Efficiency in the present invention is achieved by detonating an over-oxidized fuel mixture under a determined pressure for a sufficiently long enough period of time to completely consume all of the fuel. Upon detonation, the temperature and pressure in the chamber increase. In an embodiment, the temperature spikes to about 1000° F. and the pressure spikes to about 1400 psi. The temperature and pressure then decrease within a fraction of a second through the heat being absorbed through the wall 1150.

In an embodiment, the wall 1150 is a heat sink. In an embodiment, the chamber is enclosed in the tank and the heat sink is the interface between the enclosed chamber and the fluid in the tank. By being surrounded by a fluid, the detonation in the chamber provides very little noise. The heat sink transfers the heat produced by the detonation to the lower temperature fluid in the tank. In an embodiment, heat is conducted from the chamber through the heat sink base and then to the heat sink fins where it is immediately dissipated by thermal transfer to the fluid. The drop in temperature in the chamber also produces an immediate drop in the pressure in the chamber.

FIG. 19 depicts a diagram of the fluid flow of an embodiment. Based on the timing of the fuel and oxidizer injections into the chamber and the ignition, the controller activates the production of energy in a fluid. In an embodiment, an amount of fluid is injected into the tank 1200 via the tank inlet 1260 through the tank inlet valve 1259. In an embodiment, the fluid is delivered directly to the wall 1150. After the tank inlet valve 1259 is closed, the energy at the wall 1150 energizes the fluid to an energized fluid in the tank 1200. The energized fluid leaves the tank 1200 through the tank outlet 1270 upon the opening of the tank outlet valve 1258. Flow, or the amount of energized fluid emitted per minute from the tank, is determined by factors such as the size of the chamber and tank, the fluid used, the frequency of detonations, and the like. Energized fluid production is also related to the type of fuel used (based on the fuel's detonation temperature, which produces a given calories per unit).

The tank outlet 1270 is connected to at least one machine 1220. In an embodiment, the machine 1220 includes, or is, one or more storage tank equipped to store a pressurized gas. As the machine 1220 uses the energy in the energized fluid, the energized fluid is routed to a reservoir 1210, which has a reservoir valve 1211. The fluid in the reservoir 1210 is re-injected into the tank 1200. In an embodiment, the fluid system is closed. In an embodiment, the fluid system includes means to add one or more fluid to the system.

Referring again to FIG. 17, when power is requested, the rate of detonation increases. When the demand stops, the rate of detonation stops. The length of time between detonations ranges from a fraction of a second to a complete stop of the engine. In an embodiment, the present invention is a device useful for the detonation of a low caloric fuel. During detonation, the fuel burns quickly producing lower temperatures than higher calorie fuels. By cooling the chamber rapidly after detonation, the detonation of the fuel produces only water and carbon dioxide. The products of detonation are not hot enough for a long enough time for radical oxygen or radical nitrogen atoms to form any nitrogen/oxygen toxic combinations. Any water in the chamber is vaporized upon detonation, but quickly reforms into water molecules as the temperature drops. As the water molecules interact with other water molecules, droplets form. The reversion of the vaporized water to a fluid in the chamber consumes energy, aiding in the cooling of the chamber. The resulting pressure in the chamber is only slightly greater than the pressure before detonation.

Referring to FIG. 18, after detonation the controller opens and closes the exhaust valve 1381 to emit an amount of detonation products. The controller modifies the amount of detonation products retained in the chamber to provide the optimum pressure for the next detonation. The controller times the releases of the exhaust products from the chamber to avoid heat loss. The controller times the detonations to allow a portion of the detonation products to be exhausted and the next oxidizer-fuel mixture to enter the chamber.

The controller determines the optimum pressure in the chamber based on the request for power and releases exhaust products prior to the subsequent injection of oxidizer and fuel. Because the pressure in the chamber is increased by detonation products after detonation occurs, the exhaust process is extended as long as possible to provide optimal conditions for the next detonation. In an embodiment, the controller injects oxidizer prior to closing the exhaust valve to assist the exhaust process. In an embodiment, the exhausting of the detonation products is varied to allow a larger amount of detonation products to remain in the chamber, such as in response to a demand for a large amount of power. Because the higher concentration of detonation products causes inefficient operation of the engine, the controller increases the detonation rate.

In an embodiment, the controller is programmed to limit the detonation rate. Limiting the detonation rate controls the diminishing returns on power over efficiency. In such cases, more than one of the present invention can be used to provide the requested amount of power.

In an embodiment depicted in FIG. 18, the controller emits detonation products through the exhaust valve 1381 to power the compressor 1400. In an embodiment, the compressor 1400 compresses outside air which flows to an oxidizer holding compartment for use as an oxidizer. In an embodiment, other types of oxidizers, such as but not limited to oxygen, hydrogen peroxide, and the like are provided to the oxidizer holding compartment.

The present invention continues the detonation of the fuel at the detonation rate as adjusted based on changes in the request for power and other data received from the components of the engine. The detonation rate drops upon a negative request for power. When the detonation rate equals zero, the controller stops the injection of fuel and oxidizer. When the user or the machine no longer requests power, the process is terminated, and the engine stops.

As illustration of the process of the engine of the present invention, and not to limit the disclosure, the following example is provided:

In an embodiment, propane is used as a fuel and air is used as an oxidizer. A user inputs “propane” and “air” into the PLC. The PLC uploads data from the gauge to establish a chamber temperature value and data from the chamber sensor to establish a chamber pressure value within the PLC. The PLC receives a request for power. In this example, the request for power is a second machine that provides thrust. The PLC calculates a detonation rate based on the properties listed in its memory for propane and air, the chamber temperature and pressure, and the amount of thrust requested.

The PLC directs the fuel injector to inject an initial amount of approximately 40 cu. in. of propane at approximately 30 psi into the chamber through the fuel valve. The PLC opens the oxidizer valve to introduce an initial quantity of about 400 cu. in. of air at 60 psi into the chamber from a compressed air storage tank. The valves close and the air-fuel mixture is contained within the chamber. After a mixing time determined from the detonation rate, the PLC activates a spark plug to provide a spark within the chamber that detonates the air-fuel mixture. The detonation creates a wave of heat that immediately expands to the wall of the chamber.

In this example, the wall is a heat sink with a first side forming the interior of the chamber and an opposite side positioned in a tank that surrounds the chamber. In an embodiment, the wall is a heat sink with the base of the heat sink forming the interior of the chamber and the fins on the opposite side of the heat sink extending into a tank that surrounds the chamber. Based on the detonation rate, the PLC directs an injector connected to a tank to spray an amount of water in droplet form onto the fins. The valves to the tank are closed. The water droplets are immediately vaporized to steam upon contact with the fins and the pressure builds in the tank.

The consumption of the energy from the detonation by the water instantly drops the temperature and pressure in the chamber. Based on the detonation rate, the PLC opens the exhaust valve for a determined amount of time and the remaining pressure in the chamber exhausts a portion of the products of the detonation to drive a compressor that compresses fresh air into a storage tank.

Based on the thrust request, the PLC opens the tank outlet and the steam jets from the tank at a temperature in the range from about 225° F. to about 300° F. and at a pressure of about 200 psi to about 500 psi depending on the request for power. The tank outlet directs the pressurized steam to the machine to provide power. Upon use by the machine, the steam cools and is routed to a reservoir that is connected to the water injector for reintroduction into the tank when directed by the PLC. In an embodiment, at least one of cooled steam and water are reintroduced into the tank. In an embodiment, the water includes an antifreeze compound.

After detonation, the PLC resets the PLC chamber temperature and pressure based on input from the chamber sensor and gauge, applies any change in the request for thrust, and recalculates the detonation rate. In an embodiment, the detonation rate maintains the wall at an optimal running temperature. In an embodiment, the running temperature is from about 350° F. to about 400° F. One skilled in the art would understand that the wall temperature varies based on factors such as but not limited to the type of fuel(s), the type of oxidizer(s), the type of fluid(s), the construction of the chamber the tank and the wall, the demand for power, and the like. Based on the current detonation rate, the PLC initiates the process for subsequent detonations. In this example, the PLC samples and calculates at given intervals and adjusts the detonation rates accordingly.

In an embodiment, more than one of the present invention are used to produce power. In an embodiment, one or multiple chambers produce energized fluid in one joint tank or in individual tanks coupled to each engine. In an embodiment, each energized fluid outlet is connected to more than one machine and or more than one storage tank. In an embodiment, multiple outlets are connected to one machine and or one storage tank. In an embodiment, the energized fluid is compressed in a storage tank. In an embodiment, the present invention is combined with other systems, such as other types of engines and or machines. In an embodiment, the controller directs the energized fluid to drive a compressor that compresses air into a storage tank that can used by a machine that uses compressed air. In an embodiment, the controller directs the energized fluid to drive a compressor that compresses oxidizer in an oxidizer storage compartment. In an embodiment, the present invention is used to power individual components of a machine at the same or at different times. For example, the present invention can be used to provide energized fluid in response to requests for power, but when no requests are received by the controller, the controller directs the energized fluid to drive a compressor that compresses an oxidizer and or a second gas into a separate storage tank. In an embodiment, the second gas comprises natural gas, methane, propane and the like and is stored in a fuel reservoir.

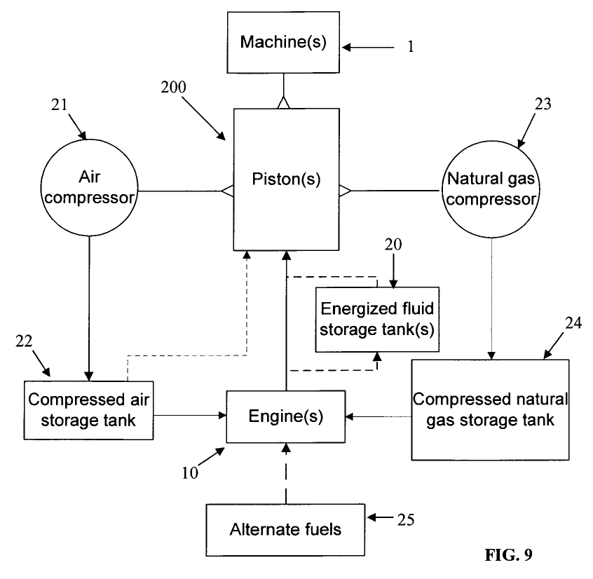

In an embodiment depicted in FIG. 9, natural gas, compressed by a compressor 23, is stored in a natural gas storage tank 24. The natural gas is used in addition to alternative fuels 25 detonated in the engine 10. The detonation is oxidized by compressed air stored in a tank 22. The air is compressed by a compressor 21. The compressor is powered by movement of the pistons 200. The detonation at the engine 10 provides energy for energizing a fluid introduced in a selected port of the cylinder housing the piston. Alternatively, the energized fluid may be stored in an energized fluid storage tank 20. The compressed air is used to provide additional power to one or more pistons in order to augment the energized fluid during periods of higher than normal torque demand, such as during acceleration or fast braking. In an embodiment, the auxiliary compressed air feed is provided to separate pistons than those using energized fluid. The movement of the pistons 200, 201 provides power to a machine 1. The machine is any tool that does work. In an embodiment, the machine is a generator, a small appliance, a vehicle, a robot, heavy machinery, and the like.

In an embodiment, the secondary pistons drive other devices. In an embodiment, the secondary pistons add torque directly to the crankshaft. In an embodiment, the secondary pistons stroke more rapidly than the pistons 200 and deliver less torque. In an embodiment, the secondary pistons add torque through gearing.

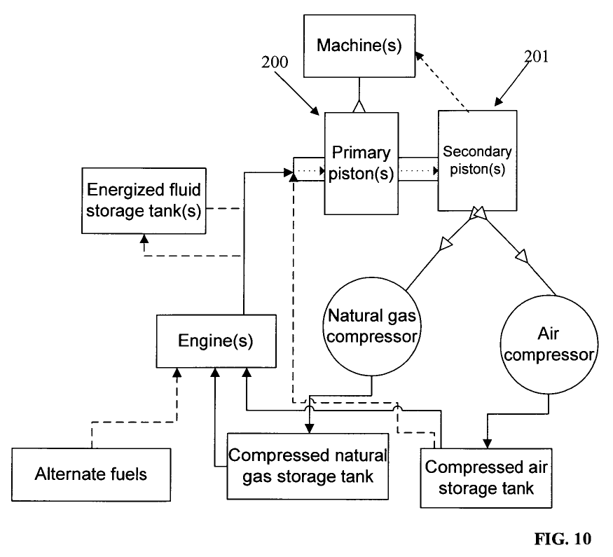

As shown in FIG. 10, the energized fluid drives pistons 200. After the pistons are directly driven through their entire stroke, the cooling fluid is directed to at least one secondary piston 201. The cooling energized fluid is injected into the secondary piston to cause a full stoke of the secondary piston. In an embodiment, the secondary piston powers at least one of the air compressor and the natural gas compressor if natural gas is available.

For example, natural gas from a hose connection in a garage or filling station is connected to a compressor in a vehicle and stored in a natural gas storage tank in the vehicle. The compressed gas is used to run the engine while the vehicle travels.

In embodiment, the fuel comprises any liquid or gaseous hydrocarbon. In an embodiment, the fuel comprises at least one of hydrogen, methane, propane, methanol, alcohol, butanol, natural gas, benzene, toluene, xylene, any petroleum oil, kerosene, gasoline, diesel, heating oil, biodiesel, ethanol, soybean oil, rapeseed oil, animal fat, microalgae oil, vegetable oil, mixtures thereof, and the like. This list is not all inclusive but is merely representative of suitable fuels.

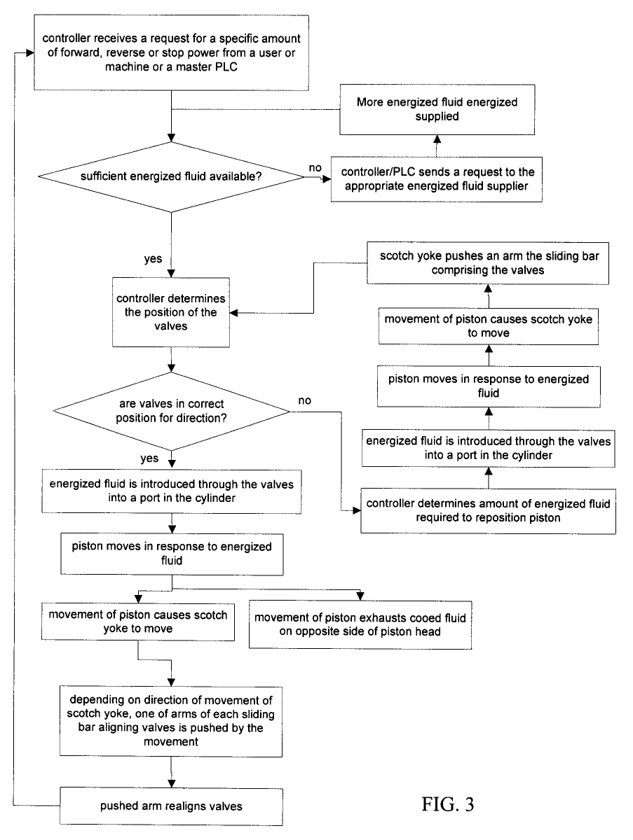

As depicted in an embodiment shown in flowchart form in FIG. 3, the motor initiates with the controller receiving a request for a specific amount of forward, reverse, or stopping power from a user or machine or a master PLC. Upon confirmation of sufficient energized fluid by the controller/PLC, the controller determines the position of the sliding bars. Where the sliding bars would provide the opposite rotation for the requested direction, then the flow of energized fluid to the pistons is reversed. The movement of the piston causes the scotch yoke to move, which exerts a pressure on mirrored arms attached to each slider bar, causing it to move. The movement of the slider bar positions a valve in the first slider bar with a port in the cylinder wall which allows energized fluid from an inlet into the cylinder. The pressure from the fluid pushes the piston. The movement of the second slider bar positions a valve in the second slider bar with a port in the cylinder wall which allows cooling fluid to be exhausted by the force of the moving piston from the cylinder to an outlet.

As the piston continues to move, the scotch yoke is moved, which exerts a pressure on a first arm attached to each slider bar, moving the bar. The movement of the slider bar moves the first valves to close the first ports. The movement positions a second valve in the slider bar with a second port in the cylinder wall which allows energized fluid from an inlet into the cylinder. The movement of the second slider bar positions a second valve in the second slider bar with a second port in the cylinder wall which allows cooling fluid to be exhausted by the force of the piston moving from the energized fluid on the opposite side of the piston. When the piston moves in response to the energized fluid, the scotch yoke is moved, which exerts a pressure on a second arm attached to the slider bar, moving the bar in the opposite direction. The cycle repeats as long as there is a demand for power. The speed of the motor is regulated by the movement of the valves and the introduction of energized fluid. The controller and or the PLC determines how fast, how far and how long each valve opens.

In an embodiment, different amounts of energized fluid are introduced to either side of the piston. In an embodiment, the amount of energized fluid introduced to each side of the piston is the same.

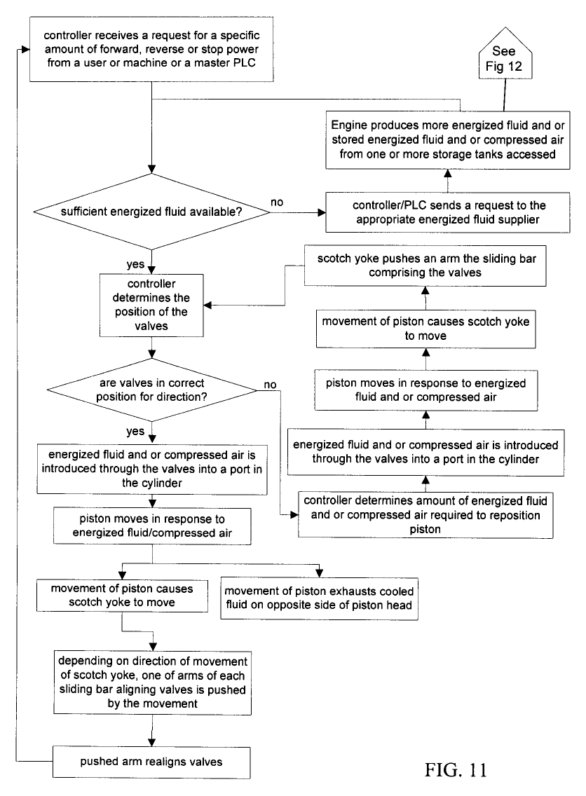

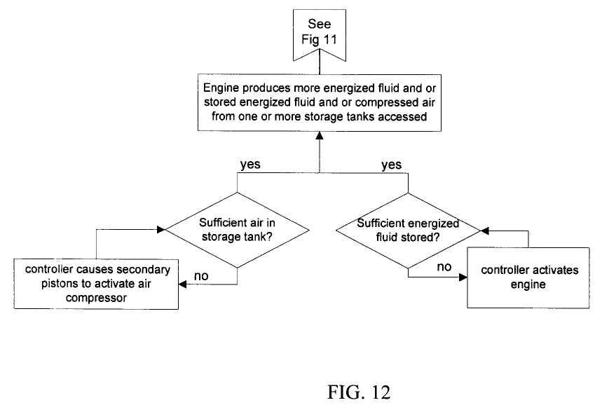

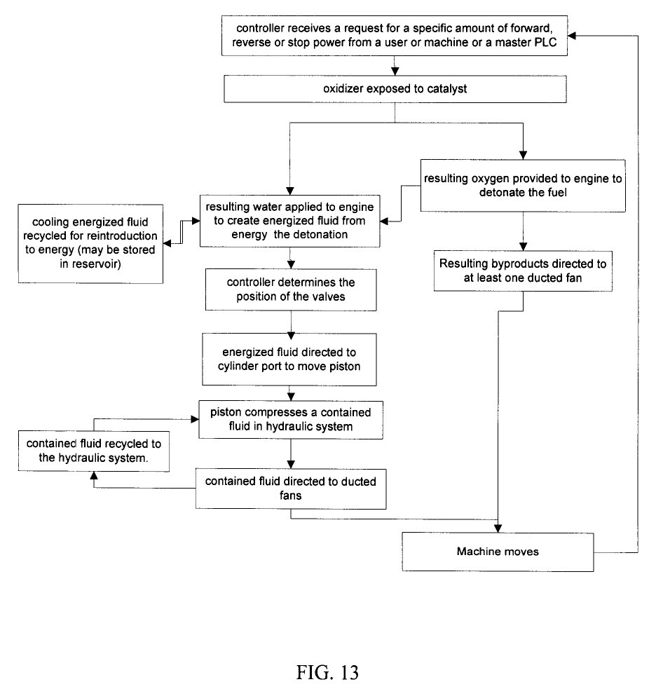

As depicted in FIG. 11, the present invention, upon the controller receives a request for a specific amount of forward, reverse or stop power from a user or machine or a master PLC, an engine is caused to produce more energized fluid and or stored energized fluid and or compressed air from one or more storage tanks is accessed to drive the pistons. As shown in FIG. 12, the controller controls the components to provide the most efficient or available means of operation.

In an embodiment, the present invention comprises a compressed air system. The compressed air is used both as an oxidizer and as an energized fluid. In an embodiment, the compressed air is stored in a tank interconnected to an engine. In an embodiment, the compressed air is injected into an engine to detonate a fuel. In an embodiment, the compressed air tank is interconnected to a motor. In an embodiment, compressed air is injected into the cylinder to move the piston. In an embodiment, compressed air is injected into a supplemental cylinder/piston interconnected with cylinder/piston(s) powered by a different energized fluid to add torque.

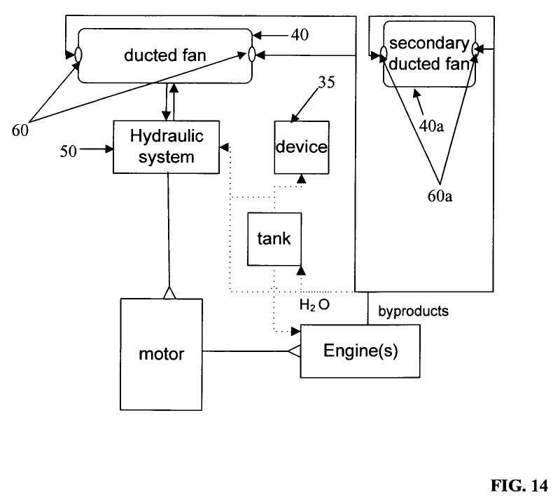

In an embodiment, exhaust byproducts, such as carbon dioxide (CO₂) and water (H₂O) from the detonation of the fuel in the engine are used and or stored. In an embodiment, water is extracted from the exhaust of the detonation and stored. In an embodiment, the water is stored in a tank 20. In an embodiment, the water is used as a fluid for creating the energized fluid. In an embodiment, the water is used as a contained fluid for a hydraulic drive (see FIG. 14).

In an embodiment depicted in FIG. 14, the water from the detonation of the fuel is used to provide an action to a device 35, such as but not limited to, a fluid drill bit, where the water acts as, or is added to, a drilling fluid that is pumped through nozzles at the drill bit. Water-based drilling fluids are preferred over oil-based fluids for economic and environmental reasons.

FIG. 14 depicts an embodiment of the present invention comprising an interconnected ducted fan 40. The ducted fan is unidirectional or reversible, allowing operation in a forward, reverse and or braking manner. In an embodiment, the axle of the ducted fan is interconnected to a crankshaft. In an embodiment, the ducted fan is enclosed. The fan comprises controlled intakes 60 at ends on either side of the fan. In an embodiment, the energized fluid powers a hydraulic system 50 that powers the ducted fan 40.

In an embodiment, byproducts of detonation of a fuel are directed to an intake 60 of the ducted fan 40. In an embodiment, energized fluid produced by the engine is injected into the intake 60 of the ducted fan 40. The byproducts and or the energized fluid provide additional mass to increase or create thrust. The intake 60 is located at both ends of the ducted fan 40 such that the byproducts and or the energized fluid are introduced at the appropriate end of the ducted fan 40 to provide mass products for the direction of thrust.

In an embodiment, the present invention comprises a hydraulic system 50. The piston in the motor generates pressure on a fluid contained in the hydraulic system 50. The contained fluid is used to provide torque, such as to a crankshaft to power a machine, or may be introduced directly to a machine. In an embodiment, the hydraulic system 50 uses conventional principles to provide drive to rotate blades of the ducted fan 40. In an embodiment, the contained fluid is introduced into the enclosed ducted fan through the appropriate intake 60 to obtain the desired direction of rotation. Use of a hydraulic drive allows the ducted fan to rotate at very high rpms, such as at about 20,000-50,000 rpms. After use in the ducted fan 40, the contained fluid is returned to the hydraulic system 50.

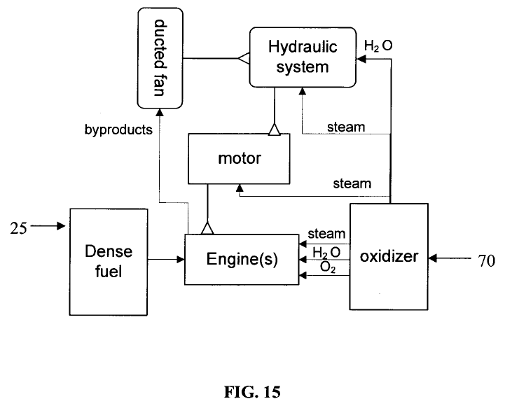

In an embodiment, the present invention comprises at least one interconnected engine, motor, ducted fan and a hydraulic system. The engine is interconnected to at least one fuel supplier. In an embodiment depicted in FIG. 15, the engine is interconnected to suppliers of at least one containerized oxidizer 70 and a dense fuel 25. In an embodiment, the oxidizer is hydrogen peroxide and the dense fuel is a heating oil or diesel. Use of hydrogen peroxide as an oxidizer is less dangerous to use and store than liquid oxygen. Heating oil or diesel is much safer and has more BTUs per pound, if extracted, than liquid hydrogen.

The oxidizer is exposed to a catalyst to produce oxygen and water. In an embodiment, hydrogen peroxide is the oxidizer. In an embodiment, the present invention is used in an anaerobic environment and hydrogen peroxide is used as an oxygen source, water source, and energy source. Hydrogen peroxide decomposes into steam and oxygen when exposed to a catalyst, such as silver, platinum, and the like. In an embodiment depicted in FIG. 15, steam from the catalyzed hydrogen peroxide is transferred to the hydraulic system 50 to act as the contained fluid and or transferred to the engine to provide heat. Water from the catalyzed oxidizer is turned to steam after exposure to the energy produced by the detonation of the dense fuel 25 in the engine by igniting the fuel in the presence of the oxygen (O₂) produced from the catalyzed oxidizer. Steam from the catalyzed oxidizer is introduced to a side of a piston in a cylinder of the motor, causing the piston to pressurize a contained fluid in the hydraulic system 50. The pressurized contained fluid is introduced into a drive port at the ducted fan, causing rotation of an axle of the fan. The byproducts from detonation at the engine are injected into the appropriate intake 60 of the ducted fan to increase the mass of the intake products which will increase the thrust.

By interconnected an engine, a motor, and a ducted fan, power may be supplied to a machine for long periods in the absence of an atmosphere. The present invention is useful for machines operating in anaerobic or low oxygen environments, such as but not limited to high altitudes, space, under water, mines, in construction, in drilling, and the like. The configuration provides a light weight device that works efficiently on the fuels contained in the device for long periods without outside temperature or pressure concerns. The device works efficiently and, as the atmospheric pressure decreases, the ducted fans operate at a faster rpm with the same torque. As the atmosphere thins, the byproducts continue to supply matter for thrust and with less overall resistance the ducted fans will increase in rpms thereby producing the maximum thrust. The present invention requires much less fuel to reach escape velocity than the current approach. When the fans are reversed, the present invention requires much less fuel to reduce the speed. The invention is useful for reentry of a vehicle from space for descent. Reverse thrust is supplied over a much longer period than conventional reentry devices. The ducted fans have instantaneous thrust level control and are easily started, stopped and turned for directional control including reverse.

With the appropriate thrust to weight ratio, the engines, motors and ducted fans are sized such that hovering is possible. In an embodiment where the present invention powers a vehicle having an appropriate thrust to weight ratio, the vehicle can ascend directly out of the atmosphere of earth.

In an embodiment, byproducts of the detonation are directed to the ports of a ducted fan, which exhausts the byproducts out through a nozzle. By introducing the byproducts to the ducted fan, thrust is created. The thrust can be maintained not only at high altitudes but even into the almost pure vacuum of space. Escape velocity is achieved by flying higher and faster into the thinning atmosphere. The present invention is adaptable to marine devices, where the hydraulic drive is used to power propellers.

In an embodiment, hydraulic driven fans are located at specific locations on the machine. By locating the fans at specific locations, three dimensional control us provided, useful for steering, such as with a vehicle. In an embodiment, the controller 900 is linked to a second controller remote from the present invention, providing remote control of the invention and a machine powered by the invention.

In an embodiment, the pressurized contained fluid drives the motor that drives a hydraulic system that drives at least one ducted fan to provide reverse or forward thrust, while secondary ducted fans 40a located at specific locations, provide steering. Byproducts are introduced into the intake 60a at either end of the secondary ducted fan 40a to provide forward or reverse thrust mode of operation. The secondary ducted fans provide reverse or forward thrust of a considerably smaller magnitude in a different direction than the first fan. In an embodiment, the secondary ducted fans provide differential thrust to produce a three-dimensional moment, such as for steering. In an embodiment, the secondary ducted fans 40a are located at specific locations on the machine.

In an embodiment, the present invention provides a means to decrease the rotation of the crankshaft. In an embodiment, when a request to slow down an or stop the machine (in a faster manner than by decreasing the amount of energized fluid) is received, the controller reverses the sequence of introduction of energized fluid to the cylinder to the opposite port based on a set program to slow and or stop the motor. The piston slows and reverses direction. In an embodiment, a transmission is added to the present invention.

The present invention is constructed of any durable material, such as but not limited to a combination of steel and aluminum. In an embodiment, steel is used for the crankshaft, valves, connecting rods and scotch yoke. In an embodiment, aluminum is used for the piston head, cylinder and crank. One skilled in the art would understand that construction material will vary depending on the required torque and or desired packaging.

The present invention is lighter and smaller than conventional motors while producing similar or greater torque at minimal revolutions. The present invention is adaptable as a power plant, such as but not limited to an electric motor, combustion engine, and the like. Torque can be generated to the maximum pressure starting from zero revolutions per minute. The control of the valves creates complete control over the piston movement, and therefore, the motor runs very smoothly.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

I claim:

1. A motor comprising:
at least one piston slideable within a cylinder with a seal, said cylinder comprising at least a first set of ports and a second set of ports, said ports disposed in a wall of the cylinder;
a plurality of valves, said valves coupled and slideable to allow a selective transfer of an energized fluid in, and an exhaust out, of the cylinder via the ports;
means to determine the position of the valves and a head of the piston;
means to select the ports in which to transfer the energized fluid in and the exhaust out of the cylinder; and
a scotch yoke operatively interacting with a crankshaft, the piston operatively connected to the scotch yoke such that, when the energized fluid moves the piston, torque is applied to the crankshaft, and the valves are repositioned to allow the energized fluid to enter the cylinder on the opposite side of the head of the piston and the exhaust to exit the cylinder.

2. The motor of claim 1 wherein at least one second piston in a second cylinder is operatively connected to the scotch yoke on an opposite side of the scotch yoke.

3. The motor of claim 1 wherein at least one second piston in a second cylinder is operatively connected to a second scotch yoke operatively connected to the crankshaft.

4. A motor comprising at least two of the double pistons of claim 2 connected to the same crankshaft.

5. The motor of claim 3 wherein the second piston is connected to the crankshaft in a different plane than the first piston.

6. A motor comprising at least one piston of claim 1 and at least one double pistons of claim 2 connected to the same crankshaft.

7. The motor of claim 1 wherein the means to select the ports is accomplished by the scotch yoke pushing on at least one arm extending from a sliding bar, said sliding bar positioning the valves.

8. The motor of claim 7 wherein positioning of the valves causes the motor to operate in one of a reverse manner, a forward manner, and a stopping manner.

9. A method of using the motor of claim 1 comprising the steps of:
determining whether a sufficient amount of energized fluid is available based on a request for forward, reverse or stopping power;
determining the position of the slide valves;
determining which valve settings to use for input and exhaust of the fluid;
determining and controlling the amount of fluid to input;
positioning the valves;
inputting and exhausting the fluid based on a movement of the piston;
repeating the above steps.

10. The motor of claim 1 wherein at least one second piston in a second cylinder having its own valves and scotch yoke are connected to the same crankshaft at various angles and in various planes in relation to each other.

11. The motor of claim 1 further comprising an engine, said engine interconnected to the cylinder and providing the energized fluid.

12. The motor of claim 11 wherein the engine provides energized fluid to more than one piston.

13. The motor of claim 3 wherein each piston is connected to an engine, said engine providing energized fluid to the corresponding piston.

14. The motor of claim 11 further comprising a storage tank.

15. The motor of claim 11 comprising a compressed air system.

16. The motor of claim 15 wherein compressed air is injected into the cylinder to move the piston and into the engine to detonate a fuel.

17. An apparatus comprising:
a motor comprising: at least one piston slideable within a cylinder with a seal, said cylinder comprising at least a first set of ports and a second set of ports, said ports disposed in a wall of the cylinder; a plurality of valves, said valves coupled and slideable to allow a selective transfer of an energized fluid in, and an exhaust out, of the cylinder via the ports; means to determine the position of the valves and a head of the piston; and means to select the ports in which to transfer the energized fluid in and the exhaust out of the cylinder; wherein the valves are repositioned to allow the energized fluid to enter the cylinder on the opposite side of the head of the piston and the exhaust to exit the cylinder;
an engine, said engine interconnected to the cylinder and providing the energized fluid; and
a ducted fan.

18. The apparatus of claim 17 comprising a hydraulic system.

19. The apparatus of claim 18 wherein a pressurized liquid from the hydraulic system is directed to drive the ducted fan.

20. The apparatus of claim 17 wherein a byproduct from a detonation in the engine is directed to an intake of the ducted fan.

21. The apparatus of claim 18 wherein the engine is interconnected to a first fuel supplier supplying an oxidizer and a second fuel supplier supplying a dense fuel.

22. The apparatus of claim 19 comprising at least one secondary ducted fan wherein byproducts from the detonation are directed to the secondary ducted fans; said ducted fans providing thrust, said secondary ducted fans located at other specific locations on a machine and providing three dimensional control.

23. A method of using the apparatus of claim 22 comprising the steps of:
exposing the oxidizer to a catalyst;
providing oxygen resulting from the catalyzed oxidizer to the engine to detonate the dense fuel;
collecting water resulting from the catalyzed oxidizer in a tank;
collecting energized fluid resulting from the catalyzed oxidizer in a reservoir;
contacting the water to a side of the engine to create additional energized fluid from energy produced by the detonation;
directing the energized fluid to a port on a cylinder of the motor to move the piston;
compressing a liquid contained in the hydraulic system through the movement of the piston;
exhausting the cooling energized fluid to the reservoir;
directing the byproducts to the ducted fans;
directing the compressed liquid to the ducted fans;
collected the liquid after exiting the ducted fans; and
returning the liquid to the hydraulic system.
